(19) United States
(12) Patent Application Publication
(10) Pub. No.: US 2021/0284486 A1
(43) Pub. Date: Sep. 16, 2021

(54) MANAGING ELEVATOR CALL ASSIGNMENTS IN RESPONSE TO ELEVATOR DOOR REVERSALS

(71) Applicant: Otis Elevator Company, Farmington, CT (US)

(72) Inventors: Ravikiran Singaraju, Hyderabad (IN); Daniel P. Archibald, Harrison, NY (US)

(21) Appl. No.: 16/953,840

(22) Filed: Nov. 20, 2020

(30) Foreign Application Priority Data
Mar. 14, 2020 (IN) 202011010995

(51) Int. Cl. B66B 1/28; B66B 1/24; B66B 13/22

(52) U.S. Cl. CPC B66B 1/28; B66B 2201/23; B66B 13/22; B66B 1/2408

(57) ABSTRACT

A method of processing elevator calls in an elevator system. The method includes counting a number of elevator door reversals at an elevator car; comparing the number of elevator door reversals to an elevator door reversal threshold; upon the number of elevator door reversals exceeding the elevator door reversal threshold, reassigning at least one elevator call for the elevator car to one or more second elevator cars.

### FOREIGN PRIORITY

This application claims priority to Indian Patent Application No. 202011010995, filed Mar. 14, 2020, and all the benefits accruing therefrom under 35 U.S.C. § 119, the contents of which in its entirety are herein incorporated by reference.

### BACKGROUND

The embodiments herein relate generally to elevator systems, and more particularly, to an elevator system that includes methods and systems for managing elevator call assignments in response to elevator door reversals.

Elevator systems employ elevator doors (e.g., landing doors and/or elevator car doors) that provide for entry to and exit from an elevator car. A door reversal occurs when an elevator door is closing, and an event causes the elevator door to open. At any busy job site, during peak hours, it is quite common to see passengers getting annoyed if the elevator performs an elevator door reversal multiple times before actually closing.

### BRIEF SUMMARY

According to an embodiment, a method of processing elevator calls in an elevator system includes counting a number of elevator door reversals at an elevator car; comparing the number of elevator door reversals to an elevator door reversal threshold; upon the number of elevator door reversals exceeding the elevator door reversal threshold, reassigning at least one elevator call for the elevator car to one or more second elevator cars.

In addition to one or more of the features described herein, or as an alternative, further embodiments may include detecting a peak mode of the elevator system; wherein the counting the number of elevator door reversals occurs only during the peak mode.

In addition to one or more of the features described herein, or as an alternative, further embodiments may include wherein the reassigning at least one elevator call for the elevator car to one or more second elevator cars comprises reassigning elevator calls for the elevator car within N floors of the elevator car.

In addition to one or more of the features described herein, or as an alternative, further embodiments may include resetting the number of elevator door reversals to zero upon the elevator car traveling the N floors.

In addition to one or more of the features described herein, or as an alternative, further embodiments may include resetting the number of elevator door reversals to zero upon the elevator car completing a run of the elevator car.

In addition to one or more of the features described herein, or as an alternative, further embodiments may include wherein the elevator door reversal threshold is a count of door reversals.

In addition to one or more of the features described herein, or as an alternative, further embodiments may include wherein the elevator door reversal threshold is a count of door reversals per time.

According to another embodiment, an elevator system includes an elevator controller configured to perform: counting a number of elevator door reversals at an elevator car; comparing the number of elevator door reversals to an elevator door reversal threshold; upon the number of elevator door reversals exceeding the elevator door reversal threshold, reassigning at least one elevator call for the elevator car to one or more second elevator cars.

In addition to one or more of the features described herein, or as an alternative, further embodiments may include the elevator controller is further configured to perform: detecting a peak mode of the elevator system; wherein the counting the number of elevator door reversals occurs only during the peak mode.

In addition to one or more of the features described herein, or as an alternative, further embodiments may include wherein the reassigning at least one elevator call for the elevator car to one or more second elevator cars comprises reassigning elevator calls for the elevator car within N floors of the elevator car.

In addition to one or more of the features described herein, or as an alternative, further embodiments may include wherein the elevator controller is further configured to perform: resetting the number of elevator door reversals to zero upon the elevator car traveling the N floors.

In addition to one or more of the features described herein, or as an alternative, further embodiments may include wherein the elevator controller is further configured to perform: resetting the number of elevator door reversals to zero upon the elevator car completing a run of the elevator car.

In addition to one or more of the features described herein, or as an alternative, further embodiments may include wherein the elevator door reversal threshold is a count of door reversals.

In addition to one or more of the features described herein, or as an alternative, further embodiments may include wherein the elevator door reversal threshold is a count of door reversals per time.

According to another embodiment, a computer program product is embodied on a non-transitory computer readable medium, the computer program product including instructions that, when executed by a processor, cause the processor to perform operations including counting a number of elevator door reversals at an elevator car during a run of the elevator car; comparing the number of elevator door reversals to an elevator door reversal threshold; upon the number of elevator door reversals exceeding the elevator door reversal threshold, reassigning at least one elevator call for the elevator car to one or more second elevator cars.

Technical effects of embodiments of the present disclosure include the ability to reassign elevator car calls in the event of elevator door reversals.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 depicts an elevator system that may employ various embodiments of the present disclosure;

FIG. 2 depicts a process of managing elevator call assignments in response to elevator car door reversals in an example embodiment;

FIG. 3 depicts managing elevator call assignments in response to elevator car door reversals in an example embodiment;

FIG. 4 depicts a process of managing elevator call assignments in response to elevator car door reversals in another example embodiment.

### DETAILED DESCRIPTION

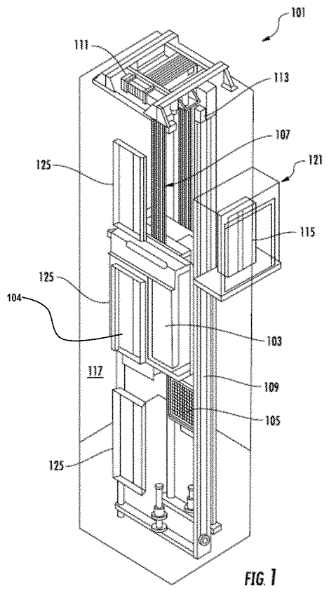

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within a hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the hoistwayl17, such as on a support or guide rail, and may be configured to provide position signals related to a position of the elevator car 103 within the hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the hoistway 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller 115 may be located remotely or in a distributed computing network (e.g., cloud computing architecture). The controller 115 may be implemented using a processor-based machine, such as a personal computer, server, distributed computing network, etc.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within hoistway 117.

The elevator system 101 also includes one or more elevator doors 104. The elevator door 104 opens to allow passengers to enter and exit the elevator car 103. The elevator door 104 may be integrally attached to the elevator car 103, referred to as an elevator car door. The elevator door 104 may be located on a landing 125 of the elevator system 101, referred to as a landing door. A reference to elevator door 104 is intended to cover one or both of the elevator car door and the landing door, unless otherwise specified. Embodiments disclosed herein may be applicable to both an elevator car door 104 integrally attached to the elevator car 103 and a landing door 104 located on a landing 125 of the elevator system 101, or both.

Although shown and described with a roping system including tension member 107, elevator systems that employ other methods and mechanisms of moving an elevator car 103 within the hoistway 117 may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

The elevator door 104 of the elevator system 101 is configured to open even during a closing process under certain circumstances. This is referred to herein as a door reversal. For example, the elevator door 104 may be closing and a passenger may use their arm to stop the elevator door 104 and cause a door reversal. In some systems, a door reversal occurs if a passenger presses a hall call button at the landing, while the elevator door 104 is closing. A door reversal may also occur if a passenger inside the elevator car 103 presses a door open button on a car operating panel inside the elevator car 103. The occurrence of numerous door reversals can frustrate passengers due to the delay associated with each door reversal.

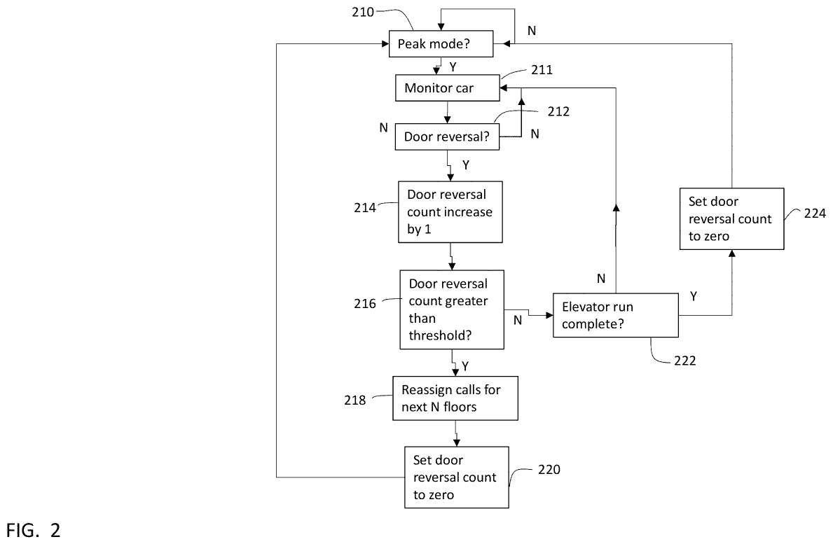

FIG. 2 depicts a process of managing elevator call assignments in response to elevator door reversals in an example embodiment. The process may be implemented by the elevator controller 115. The process begins at 210 where the controller 115 determines if the elevator system 101 is operating in a peak mode. Peak mode refers to periods where traffic on the elevator system 101 is above some limit. Peak mode may be detected based on time of day (e.g., Monday-Friday 7 AM-9 AM and 5 PM-6 PM). Peak mode may also be determined by passenger counting systems, such as people counters, etc. Passenger counting systems may use sensors/cameras to detect people moving into a lobby, sensors to count people entering a elevator car, weighing systems to determine load inside elevator cars, etc. If the elevator system 101 is not in peak mode, the process stays at 210 and waits until a peak mode occurs. In some embodiments, the elevator system 101 does not need to be in peak mode and step 210 is optional.

If the elevator system is in peak mode, flow proceeds to block 211 where monitoring of an elevator car 103 is initiated. The process of FIG. 2 may be performed for each elevator car 103 in the elevator system 101. The process of FIG. 2 focuses on a single elevator car 103 for ease of explanation.

At 212, the controller 115 determines if an elevator door reversal has occurred at the elevator car 103. If no door reversal occurs at 212, the process reverts to 211 where monitoring of the elevator car 103 continues as the elevator car 103 travels along the hoistway 117.

If an elevator door reversal occurs at 212, flow proceeds to 214 where an elevator door reversal count is incremented by one. The elevator door reversal count is typically set to zero when an elevator car run is completed (e.g., the elevator car 103 has reached an end of the hoistway 117 or the elevator car is reversing direction in the hoistway 117). At 216, the controller 115 determines if the elevator door reversal count is greater than an elevator door reversal threshold. For example, the process may be configured with an elevator door reversal threshold of five. If the elevator car 103 has not experienced more than five elevator door reversals, the process flows to 222, where the controller 115 determines if the run of the elevator car 103 is complete (e.g., the elevator car 103 has reached its final destination floor). If not, flow proceeds to 211 where the process repeats in monitoring for an elevator door reversal. If the elevator car run is complete at 222, the elevator door reversal count is set to zero at 224 and flow proceeds to 210.

If the elevator door reversal count is greater than the elevator door reversal threshold at 216, flow proceeds to 218 where the controller 115 reassigns elevator calls for the elevator car 103 for the next N (e.g., five) floors from the present floor. The elevator calls that are reassigned may be hall calls or destination calls. The reassigned elevator calls are reassigned to one or more other elevator cars 103 in the elevator system 101. The controller 115 may reassign an elevator call from a first elevator car to a second elevator car, the second elevator car being in the same group or in a different group as the first elevator car. At 218, the elevator car 103 may then travel past the next N floors, even if a passenger is waiting on a floor for the elevator car 103. At 220, the elevator door reversal count is set to zero and flow proceeds to 210.

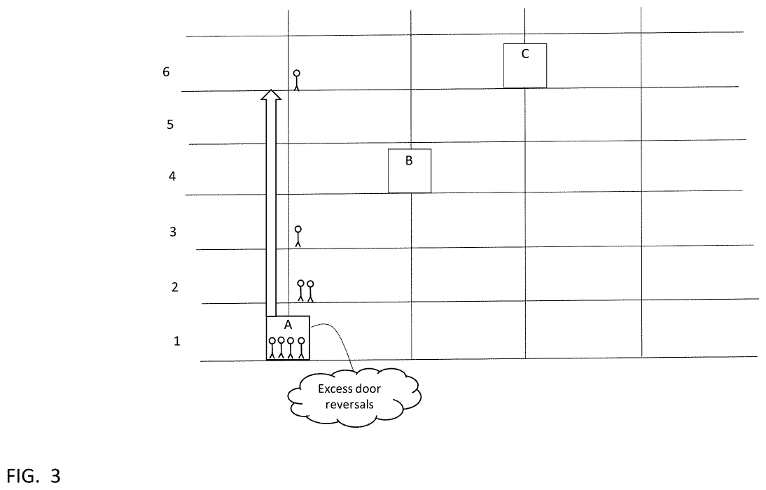

FIG. 3 depicts managing elevator call assignments in response to elevator door reversals in an example embodiment. In the example of FIG. 3, elevator car A is assigned hall calls at floor 1, floor 2, floor 3 and floor 6. In the example of FIG. 3, car A located at floor 1 has experienced more than the elevator door reversal threshold (e.g., five) of elevator door reversals. In response to the excessive elevator door reversals at floor 1, elevator car A ignores elevator calls over the next N (e.g., five) floors. The controller 115 reassigns the elevator calls for elevator car A at floors 2 and 3 to one or more second elevator cars, such as elevator car B and elevator car C. Elevator car A, having the elevator calls for floors 2 and 3 reassigned, travels N floors from floor 1 to floor 6. Upon arriving at floor 6, the elevator door reversal count may be reset to zero.

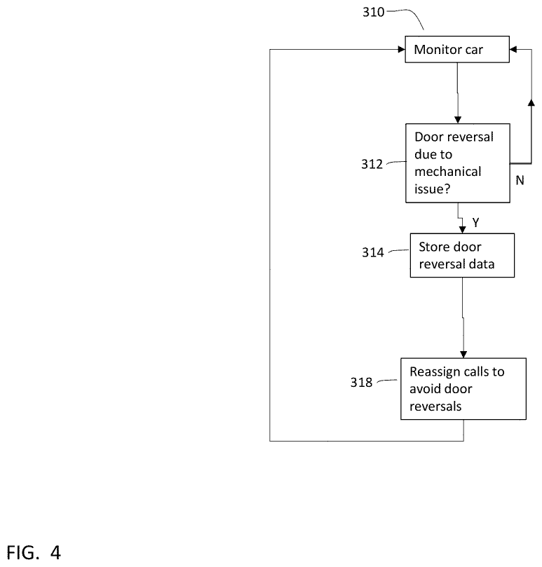

FIG. 4 depicts a process of managing elevator call assignments in response to elevator car door reversals in another example embodiment. The process of FIG. 3 may be helpful in detecting and addressing nuisance door reversals that are caused by passenger behavior. Door reversals may also happen as a result of a problem with the car door and/or the landing door itself. For example, debris in the track, misalignment of the door, failing door components, etc. may cause door reversals due to mechanical issues.

The process of FIG. 4 provides detection of door reversals due to mechanical issues and manages car assignments appropriately. The process of FIG. 4 may be executed independently of or concurrently with the process of FIG. 3. The process may be implemented by the elevator controller 115. The process begins at 310 where the controller 115 monitors an elevator car 103. The process of FIG. 4 may be performed for each elevator car 103 in the elevator system 101. The process of FIG. 4 focuses on a single elevator car 103 for ease of explanation.

At the 312, the controller 115 determines if a door reversal has occurred due to a mechanical issue. A door reversal due to a mechanical issue may be detected by the occurrence of a door reversal without a user pressing a button (either at the landing or in the elevator car) or without a user blocking the closing doors. If a door reversal occurs without some corresponding passenger cause, then it is likely the door reversal is due to a mechanical issue. However, a faulty sensor or button may cause it to appear that a reversal may be passenger-caused when, in fact, it is not. In one embodiment, the controller 115 may determine a door reversal has occurred as a result of a mechanical issue if a particular elevator car experiences door reversals on one floor in excess of a threshold value (or some other small percentage of the total floors that the elevator serves) but not other floors. For example, if the elevator car experiences a door reversal on the 5^{th} floor 3 times in a row, the controller 115 may conclude that the door reversal is caused by a mechanic issue. In one embodiment, the threshold may be a number of reversals per unit time (e.g., 3 reversals per hour), a number of consecutive reversals (e.g., 3 reversals in a row), and/or a reversal frequency (e.g., 50% reversal rate). In one embodiment, the threshold value may be 3. In one embodiment, the threshold value may be greater than or less than 3. In one embodiment, the controller 115 may determine a door reversal has occurred as a result of a mechanical issue if a particular elevator car experiences door reversals on one floor in excess of the threshold value but other elevator cars servicing that same floor do not experience door reversals in excess of the threshold value. In one embodiment, the controller 115 may determine a door reversal has occurred as a result of a mechanical issue if a particular elevator car experiences door reversals on one floor at a ratio greater than a second threshold value in comparison to other elevator cars servicing the same floor. For example, if the one elevator car experiences 50% more reversals than other elevator cars servicing the same floor, the controller 115 may determine that a door reversal has occurred as a result of a mechanical issue. In one embodiment, the ratio may be greater or less than 50%.

If at 312 the door reversal is not due to a mechanical issue, flow returns to 310. If at 312 the door reversal is due to a mechanical issue, flow proceeds to 314. At 314, the controller 115 stores door reversal data that may be used to subsequently diagnose the cause of the door reversals due to a mechanical issue(s).

From 314, the process flows to 318 where the elevator controller 115 may reassign elevator calls to avoid door reversals. For example, if a certain elevator car 103 experiences a door reversal and at a certain landing at over a threshold rate, then the controller 115 may reassign any calls for that elevator car to that floor to a second elevator car. For example, referring to FIG. 3, if elevator car A typically experiences a door reversal due to a mechanical issue at floor 5 (e.g., a mechanical misalignment issues), then future calls to floor 5 will be assigned to elevator car B. In the case of multiple banks of elevators, the controller 115 may avoid bank/landing pairs that have a higher occurrence of door reversal due to a mechanical issue. In some embodiments, an elevator car 103 may be taken out of service for maintenance if excessive door reversals due to mechanical issue(s) occur.

Embodiments provide for reassigning elevator calls in the event an elevator car experiences an excessive number of elevator door reversals. This improves the passenger experience, particularly during rush hours when elevator door reversals are more common.

As described above, embodiments can be in the form of processor-implemented processes and devices for practicing those processes, such as a processor in the controller 115. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A method of processing elevator calls in an elevator system, the method comprising:
counting a number of elevator door reversals at an elevator car;
comparing the number of elevator door reversals to an elevator door reversal threshold;
upon the number of elevator door reversals exceeding the elevator door reversal threshold, reassigning at least one elevator call for the elevator car to one or more second elevator cars.

2. The method of claim 1, further comprising:
detecting a peak mode of the elevator system;
wherein the counting the number of elevator door reversals occurs only during the peak mode.

3. The method of claim 1, wherein:
the reassigning at least one elevator call for the elevator car to one or more second elevator cars comprises reassigning elevator calls for the elevator car within N floors of the elevator car.

4. The method of claim 3, further comprising:
resetting the number of elevator door reversals to zero upon the elevator car traveling the N floors.

5. The method of claim 1, further comprising:
resetting the number of elevator door reversals to zero upon the elevator car completing a run of the elevator car.

6. The method of claim 1, wherein the elevator door reversal threshold is a count of door reversals.

7. The method of claim 1, wherein the elevator door reversal threshold is a count of door reversals per time.

8. An elevator system comprising:
an elevator controller configured to perform:
counting a number of elevator door reversals at an elevator car;
comparing the number of elevator door reversals to an elevator door reversal threshold;
upon the number of elevator door reversals exceeding the elevator door reversal threshold, reassigning at least one elevator call for the elevator car to one or more second elevator cars.

9. The elevator system of claim 8, wherein the elevator controller is further configured to perform:
detecting a peak mode of the elevator system;
wherein the counting the number of elevator door reversals occurs only during the peak mode.

10. The elevator system of claim 8, wherein:
the reassigning at least one elevator call for the elevator car to one or more second elevator cars comprises reassigning elevator calls for the elevator car within N floors of the elevator car.

11. The elevator system of claim 10, wherein the elevator controller is further configured to perform:
resetting the number of elevator door reversals to zero upon the elevator car traveling the N floors.

12. The elevator system of claim 8, wherein the elevator controller is further configured to perform:
resetting the number of elevator door reversals to zero upon the elevator car completing a run of the elevator car.

13. The elevator system of claim 8, wherein the elevator door reversal threshold is a count of door reversals.

14. The elevator system of claim 8, wherein the elevator door reversal threshold is a count of door reversals per time.

15. A computer program product embodied on a non-transitory computer readable medium, the computer program product including instructions that, when executed by a processor, cause the processor to perform operations comprising:
counting a number of elevator door reversals at an elevator car during a run of the elevator car;
comparing the number of elevator door reversals to an elevator door reversal threshold;
upon the number of elevator door reversals exceeding the elevator door reversal threshold, reassigning at least one elevator call for the elevator car to one or more second elevator cars.
